(19) United States
(12) Patent Application Publication
(10) Pub. No.: US 2026/0030980 A1
(43) Pub. Date: Jan. 29, 2026

(54) SPATIAL AUDIO ALERTS FOR DRIVER-ASSIST SYSTEMS IN TRUCKS

(71) Applicant: Stack AV Co., Mount Pleasant, PA (US)

(72) Inventors: Peter William RANDER, Mars, PA (US); Jeremy Lawrence SEAROCK, Glenshaw, PA (US)

(73) Assignee: Stack AV Co., Mount Pleasant, PA (US)

(21) Appl. No.: 18/782,534

(22) Filed: Jul. 24, 2024

(51) Int. Cl. G08G 1/0967; G08G 1/16; H04R 5/02; H04S 7/00

(52) U.S. Cl. CPC G08G 1/0967; H04R 5/02; H04S 7/302; G08G 1/165; H04R 2499/13; H04S 2400/11; H04S 2400/13

(57) ABSTRACT

A system for generating spatial audio alerts comprises one or more ultrasonic transducers disposed in a cab of a truck; one or more sensors disposed in or around the truck; one or more processors; and one or more computer readable media storing instructions that, when executed by the one or more processors, cause the system to: detect, by the one or more sensors, a hazard; identify a direction of the hazard relative to a driver of the truck; and generate a spatial audio alert, wherein generating a spatial audio alert comprises emitting, from the one or more ultrasonic transducers, an ultrasonic carrier wave modulated with audio content directed toward a location based on the direction of the hazard, wherein the ultrasonic carrier wave demodulates upon contacting an interior surface of the truck and generates a spatial audio alert audible from the location based on the direction of the hazard.

### FIELD

The present disclosure relates generally to driver-assist systems, and more specifically to spatial audio alerts for driver-assist systems in trucks.

### BACKGROUND

Advanced driver-assistance systems (ADAS) are used to detect hazards and alert drivers to increased hazard levels based on the driver's own behavior or the behavior of other vehicles, objects, or conditions surrounding the ADAS-equipped vehicle. For example, ADAS may be configured to warn drivers of lane departures or collision risks.

The ability to alert drivers to hazards is particularly important in trucking. Some trucks have large trailer attachments that inhibit a driver's ability to see vehicles or other potential hazards in the vicinity of the truck, especially those located behind or to the side of the truck (e.g., in a driver's blind spot).

Some ADAS use different alerts (e.g., different tones) to indicate different types of hazards. However, such alerts may be of limited value to a driver who is unfamiliar with the significance of each alert. These alerts may be ineffective at informing the driver of the type and location of the hazard and may require the driver to divert their attention from driving to identify the type and location of the hazard, thereby increasing risk to the driver and to surrounding vehicles. In the case of trucking, the driver may not even be able to see the hazard to determine what and where it is, since the trailer may obstruct the driver's view.

### SUMMARY

As described above, existing ADAS alerts may be unable to safely and effectively convey the type and location of a hazard to a driver. Accordingly, there is a need for improved systems, methods, and techniques for alerting drivers to the nature and location of hazards.

Described herein are systems, methods, electronic devices, non-transitory storage media, and apparatuses for generating spatial audio alerts, which may address the above-identified need. The systems and methods described herein may use spoken language alerts or other dynamic audio alerts to communicate the type, location, and/or severity of a hazard detected by one or more sensors of an ADAS-equipped vehicle, such as a truck. The alerts may be configured to sound to a driver as though they originate from a direction based on the location of the detected hazard.

An exemplary system for generating spatial audio alerts includes one or more ultrasonic transducers disposed in a cab of a truck. The system may also include one or more sensors disposed in or around the truck that may be configured to detect hazards. When the one or more sensors detect a hazard, the system may identify the direction of the hazard relative to the driver of the truck. The system may then generate a spatial audio alert by emitting an ultrasonic wave modulated with audio content from the one or more ultrasonic transducers toward a location based on the direction of the hazard. When the modulated ultrasonic wave contacts an interior surface of the cab of the truck, the carrier wave may demodulate, resulting in an audible alert that sounds to the driver as though it originated from the location based on the direction of the hazard.

Some embodiments of the systems and methods described herein include a plurality of conventional audio speakers instead of one or more ultrasonic transducers. Conventional audio speakers can be used to achieve spatial audio effects by controlling the properties of the waves emitted from the plurality of speakers. For example, the system may be configured to control the phase and/or amplitude of an audio signal emitted from at least one speaker in order to generate a spatial audio alert that sounds to the driver as though it originated from a location based on the direction of the hazard.

A system for generating spatial audio alerts comprises: one or more ultrasonic transducers disposed in a cab of a truck; one or more sensors disposed in or around the truck; one or more processors; and one or more computer readable media storing instructions that, when executed by the one or more processors, cause the system to perform a method comprising: detecting, by the one or more sensors, a hazard; identifying a direction of the hazard relative to a driver of the truck; and generating a spatial audio alert, wherein generating a spatial audio alert comprises emitting, from the one or more ultrasonic transducers, an ultrasonic carrier wave modulated with audio content directed toward a location based on the direction of the hazard, wherein the ultrasonic carrier wave demodulates upon contacting an interior surface of the cab of the truck and generates a spatial audio alert audible from the location based on the direction of the hazard.

In some embodiments, the one or more ultrasonic transducers are configured to emit ultrasonic carrier waves in a plurality of directions. In some embodiments, the one or more ultrasonic transducers are attached to at least one of: a ceiling of the cab of the truck, an interior surface of a windshield of the cab of the truck, a dashboard of the cab of the truck or an instrument panel thereof, a console of the cab of the truck, a door of the cab of the truck, a wall of the cab of the truck, a pillar of the cab of the truck, or a floor of the cab of the truck. In some embodiments, at least one sensor is used for autonomous navigation. In some embodiments, at least one sensor is attached to a trailer of the truck. In some embodiments, the hazard comprises a stopped vehicle, a merging vehicle, an object, a pothole, a construction roadblock, a traffic incident, or a lane closure. In some embodiments, the spatial audio alert comprises a spoken language alert. In some embodiments, the spoken language alert comprises a nature of the hazard. In some embodiments, the spoken language alert comprises a location of the hazard. In some embodiments, the method further comprises: repeatedly emitting the spatial audio alert; determining that the hazard no longer exists; and ceasing to emit the spatial audio alert. In some embodiments, repeatedly emitting the spatial audio alert comprises dynamically adjusting a volume of the spatial audio alert based on a distance between the hazard and the truck. In some embodiments, the volume of the spatial audio alert increases as the distance between the hazard and the truck decreases. In some embodiments, the truck is retrofitted with the one or more ultrasonic transducers.

A system for generating spatial audio alerts comprises: a plurality of speakers disposed in a cab of a truck; one or more sensors disposed in or around the truck; one or more processors; and one or more computer readable media storing instructions that, when executed by the one or more processors, cause the system to perform a method comprising: detecting, by the one or more sensors, a hazard; identifying a direction of the hazard relative to a driver of the truck; and generating a spatial audio alert, wherein generating a spatial audio alert comprises controlling a phase of an audio signal emitted from at least one speaker of the plurality of speakers to generate a spatial audio alert audible from a location based on the direction of the hazard.

In some embodiments, generating a spatial audio alert comprises controlling an amplitude of the audio signal emitted from the at least one speaker. In some embodiments, the plurality of speakers are attached to at least one of: a ceiling of the cab of the truck, an interior surface of a windshield of the cab of the truck, a dashboard of the cab of the truck or an instrument panel thereof, a console of the cab of the truck, a door of the cab of the truck, a wall of the cab of the truck, a pillar of the cab of the truck, or a floor of the cab of the truck. In some embodiments, at least one sensor is used for autonomous navigation. In some embodiments, at least one sensor is attached to a trailer of the truck. In some embodiments, the hazard comprises a stopped vehicle, a merging vehicle, an object, a pothole, a construction roadblock, a traffic incident, or a lane closure. In some embodiments, the spatial audio alert comprises a spoken language alert. In some embodiments, the spoken language alert comprises a nature of the hazard. In some embodiments, the spoken language alert comprises a location of the hazard. In some embodiments, the method further comprises: repeatedly emitting the spatial audio alert; determining that the hazard no longer exists; and ceasing to emit the spatial audio alert. In some embodiments, repeatedly emitting the spatial audio alert comprises dynamically adjusting a volume of the spatial audio alert based on a distance between the hazard and the truck. In some embodiments, the volume of the spatial audio alert increases as the distance between the hazard and the truck decreases.

In some embodiments, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for generating spatial audio alerts, according to some embodiments.

FIG. 2 illustrates an exemplary method for generating spatial audio alerts, according to some embodiments.

FIG. 3 illustrates an exemplary system for generating spatial audio alerts using an ultrasonic transducer, according to some embodiments.

FIG. 4 illustrates an exemplary system for generating spatial audio alerts using a plurality of conventional audio speakers, according to some embodiments.

FIG. 5 illustrates an exemplary computing system, according to some embodiments.

### DETAILED DESCRIPTION

As described, it can be difficult for a driver to discern the nature and location of a hazard based on an ADAS alert. Current approaches to alerting a driver to a hazard may require the driver to divert their attention from driving to discern the source of the alert, which may increase risk to the driver and to surrounding vehicles. Truck drivers may be especially challenged to discern the source of the alert due to the presence of a trailer, which can obstruct a driver's view of the rear and side surroundings of the truck.

Accordingly, provided herein are systems and methods for generating spatial audio alerts for driver-assist systems in trucks. The described systems and methods may include one or more sensors disposed in or around a cab of the truck. The truck may also be equipped with a speaker modality, such as one or more ultrasonic transducers or one or more conventional audio speakers.

When the one or more sensors detect a hazard, the system may identify the direction of the hazard relative to the driver of the truck and generate a spatial audio alert that sounds to the driver as though it originated from a location based on the direction of the hazard. Spatial audio effects can be achieved by emitting, from one or more ultrasonic transducers, an ultrasonic carrier wave modulated with audio content toward a location based on the direction of the hazard. When the modulated ultrasonic wave contacts an interior surface of the cab of the truck, the carrier wave demodulates, resulting in an audible alert that sounds to the driver as though it originated from the location based on the direction of the hazard. Alternatively, spatial audio effects can be achieved by controlling the phase and/or amplitude of one or more conventional speakers to generate the illusion of spatial audio.

The techniques described herein may provide several technical advantages. As described, alerts provided by existing driver-assist systems may be ineffective at informing drivers of the type and location of a hazard. As a result, the driver may be forced to divert their attention from driving to identify the type and location of the hazard. Furthermore, such an alert may not be useful to truck drivers, who may be unable to locate and identify a hazard to which they were alerted due to the presence of a large trailer in their rear view. The systems and methods described herein may remedy these issues by providing spatial audio alerts which indicate the nature and location of a hazard. The spatial audio alerts described herein may be configured to sound to a driver as though they originate from a direction that is based on the location of the identified hazard. The spatial audio alerts may further include spoken language alerts, which may alert drivers to the specific nature of the hazard.

Furthermore, the techniques described herein may be used to retrofit an existing truck or other vehicle which was not originally built with spatial audio capabilities. For example, a truck may be retrofit by mounting one or more ultrasonic transducers within the cab of the truck (e.g., on the ceiling, dashboard, windshield, doors, walls, pillars, etc.). The ability to create spatial audio with as little as one ultrasonic transducer may be particularly advantageous for trucks, since truck cabs are typically small and may have limited space for placing multiple speakers which may otherwise be required for generating spatial audio alerts.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

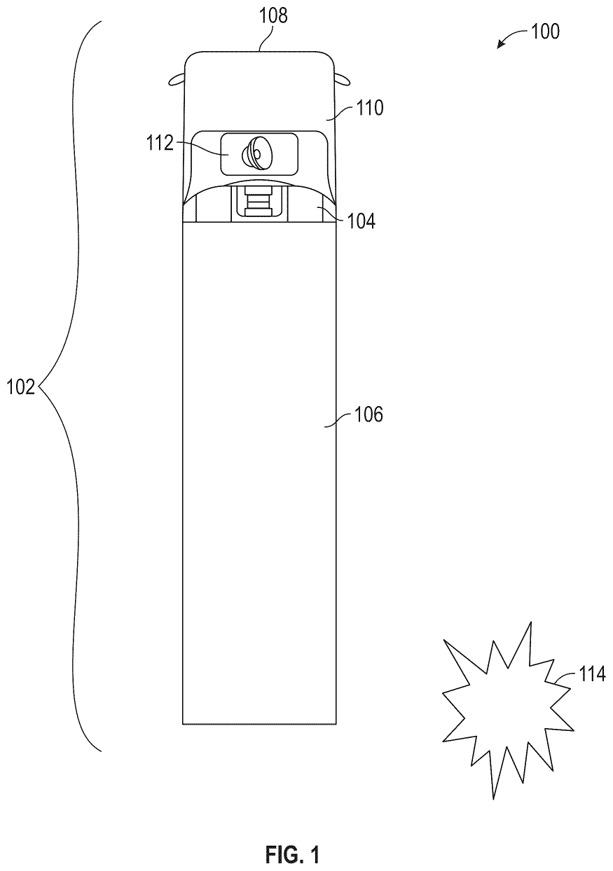

FIG. 1 illustrates an exemplary system for generating spatial audio alerts, according to some embodiments. The system 100 may include a truck 102. Truck 102 may be a truck used for the transportation of a payload such as goods, commodities, equipment, machinery, livestock, or other products. In some embodiments, truck 102 may be a semi-trailer truck which includes a cab 104 and a trailer attachment 106 for transportation of the payload. The cab 104 may be the portion of truck 102 that may be occupied by a driver and/or a passenger. The trailer attachment 106 may include, for example, a dry van (enclosed) trailer, a flatbed trailer, a Conestoga trailer, a tank trailer, or any other suitable type of truck trailer.

In some embodiments, truck 102 may not include a trailer attachment 106. Accordingly, it should be understood that truck 102 may not exclusively be a semi-trailer truck but may also be a different type of road vehicle. For example, truck 102 may optionally be a car (e.g., a sedan or a sport utility vehicle), a van (e.g., a utility van or a minivan), a pickup truck, or a bus.

In some embodiments, truck 102 may be retrofitted with one or more of the other components of system 100. For example, a standard truck without an ADAS may be retrofit with one or more sensors 108, a computing system 110, and/or one or more speakers 112 (e.g., one or more ultrasonic transducers or audio speakers) in order to generate spatial audio alerts.

Truck 102 may include one or more sensors 108 disposed in or around the truck. Sensors 108 may include one or more cameras, optical sensors, LiDAR sensors, radar sensors, ultrasonic sensors, GPS sensors, or a combination thereof. In some embodiments, truck 102 may be partially autonomous, human-operated, or configured for both autonomous and human operation. In some embodiments, if truck 102 is configured for autonomous or semi-autonomous navigation, sensors 108 may be the same sensors used for autonomous or semi-autonomous navigation. In such a case, retrofitting the truck 102 with a spatial audio alert system may be particularly desirable because existing sensors 108 may be repurposed, which may reduce the cost and effort required to implement a spatial audio alert system.

In some embodiments, one or more sensors 108 may be positioned on the exterior of truck 102. Sensors 108 may be mounted on the exterior of the cab 104, such as on the front of the cab and/or on the sides of the cab. In some embodiments, a bar of sensors 108 may be mounted on a top portion of the exterior of the windshield of cab 104. In some embodiments, sensors 108 may also be mounted on the exterior of trailer 106, such as on the back of the trailer and/or on the sides of the trailer. Mounting sensors 108 on trailer 106 may be particularly useful if trailer 106 obstructs a driver's view of their rear and/or side surroundings, in which case sensors 108 may be used to detect and inform the driver of hazards.

In some embodiments, sensors 108 may be configured to detect one or more hazards 114 located in the vicinity of truck 102. The one or more hazards 114 may include, but are not limited to, a stopped vehicle in the path of truck 102, an object other than a vehicle (e.g., fallen trees, debris, animals) in the path of truck 102, a pothole or construction roadblock in the path of truck 102, heavy traffic or a traffic incident in the path of truck 102, a lane closure in the path of truck 102, the presence of another vehicle attempting to merge into the lane of truck 102, or the presence of another vehicle in an adjacent lane into which truck 102 is attempting to merge or is drifting. In some embodiments, sensors 108 may be configured to detect additional hazards 114 if truck 102 is traveling on a surface street rather than a highway. For instance, surface street hazards 114 may include the presence of pedestrians, bicycles, emergency vehicles, or the like.

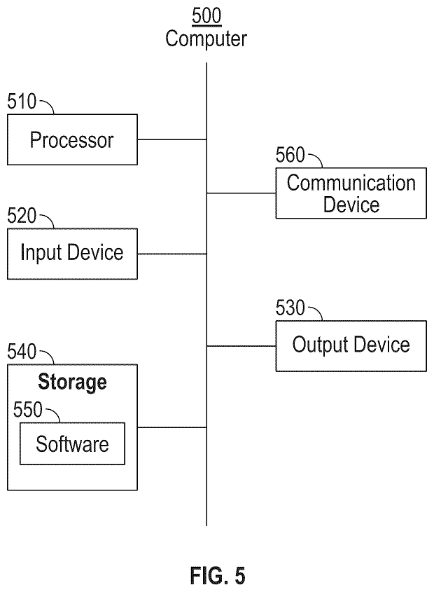

System 100 may further include a computing system 110. Computing system 110 may be integrated into truck 102 or may be a separate computing system external to truck 102. Computing system 110 may be configured to receive data from sensors 108, for instance, via a communications unit (such as communication device 560 described below with reference to FIG. 5) and process the data to generate one or more audio signals for one or more speakers 112 (e.g., using processor(s) 510 described below with reference to FIG. 5).

System 100 may also include one or more speakers 112. Speakers 112 may be disposed in cab 104 of truck 102. Speakers 112 may be configured to generate spatial audio alerts upon receiving the one or more audio signals from computing system 110. The spatial audio alerts may be configured to sound to a driver of the truck as though they originate from either the direction of the hazard or a location based on the direction of the hazard. In some embodiments, the spatial audio alerts may include spoken language alerts which communicate the nature, location, and/or severity of the hazard. In some embodiments, the spatial audio alerts may include a beep, a tone, a chime, or any combination thereof.

In some embodiments, the spatial audio alerts emitted by speakers 112 may be dynamic. A spatial audio alert may be emitted repeatedly if a hazard is present for an extended amount of time. The spatial audio alert may change over time as the hazard persists. For example, the volume of the spatial audio alert may be dynamically adjusted as the distance between the truck and the hazard changes (e.g., the volume of the spatial audio alert may become louder as the truck becomes closer to the hazard). Alternatively or additionally, the spoken language alert communicated by the spatial audio alert may be dynamically changed as the distance between the truck and the hazard changes. For instance, the spoken language alert may expressly communicate to the driver the distance between the truck and the hazard as the distance changes.

In some embodiments, speakers 112 may include one or more ultrasonic transducers. Ultrasonic transducers are devices that can generate ultrasound energy, which has a frequency greater than about 20 kHz. Due to its high frequency and short wavelength, ultrasound energy can be transmitted in a concentrated directional beam. By strategically directing the ultrasonic beam at a selected location, a system employing an ultrasonic transducer may create the illusion that audio originates from that location. Accordingly, because ultrasonic transducers work by bouncing ultrasonic beams off of surfaces at desired locations, ultrasonic transducers may be placed in locations that minimize the chances of interference with the ultrasonic beams. For example, an ultrasonic transducer may be mounted on the ceiling of the cab of the truck to prevent ultrasonic beams from inadvertently hitting objects (e.g., the driver) that can interrupt propagation of the ultrasonic beams. In some embodiments, an ultrasonic transducer may alternatively or additionally be placed or mounted on an interior surface of the windshield of the truck, the dashboard of the truck or an instrument panel thereof, the center console of the truck, one or more doors of the truck, the back wall of the truck, the floor of the truck, and/or one or more pillars of the truck (e.g., an A pillar or a B pillar). An ultrasonic transducer may also be integrated into one or more additional structures of the truck, such as the bed structure of a truck with a sleeper cab or one or more permanent or removable bins, cabinets, or consoles.

The frequency of ultrasound energy is outside of the range of human hearing. Thus, in order to generate audible signals, the ultrasonic beams emitted by an ultrasonic transducer may be modulated with audio content. In some embodiments, an ultrasonic transducer may be configured to emit an ultrasonic beam modulated with an audio signal received from computing system 110. When the modulated ultrasonic beam contacts an interior surface of truck cab 104, the beam may demodulate back into the audible frequency spectrum, and an audible alert may be produced. The audible alert may sound to the driver of the truck as though it originated from the location at which the modulated ultrasonic beam contacted the interior surface of cab 104.

In some embodiments, speakers 112 may include one or more audio speakers (e.g., wired speakers, wireless speakers, Bluetooth speakers, loudspeakers, car speakers) instead of or in addition to one or more ultrasonic transducers. The audio speakers may be integrated into cab 104 or may be separate units used to retrofit cab 104. In some embodiments, the audio speakers may be mounted to one or more interior surfaces of cab 104 (e.g., the ceiling, windshield, doors, pillars, dashboard, center console, floor, or any other suitable structure) or may be movably placed in various locations within the cab without mounting. By controlling the phase and/or amplitude of the audio emitted by the audio speakers, the illusion of spatial audio may be generated.

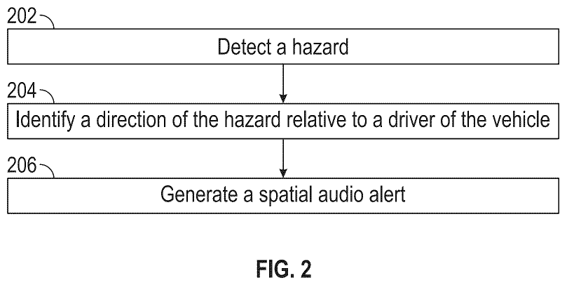

FIG. 2 illustrates an exemplary method for generating spatial audio alerts, according to some embodiments. Method 200 may be performed by system 100 described above with reference to FIG. 1. In some embodiments, some steps of the method 200 may be, optionally, combined; the order of some steps may be, optionally, changed; and some steps may be, optionally, omitted. In some embodiments, additional steps may be performed in combination with the method 200. Accordingly, the operations as illustrated (and described in greater detail below) are exemplary by nature and, as such, should not be viewed as limiting.

Method 200 may begin at step 202, wherein step 202 includes detecting a hazard. A hazard can be detected by one or more sensors disposed in or around a truck (e.g., about the exterior and/or interior of the truck), such as sensors 108 described above with reference to FIG. 1. The one or more sensors may comprise cameras, optical sensors, LiDAR sensors, radar sensors, ultrasonic sensors, GPS sensors, or a combination thereof. In some embodiments, if the truck is configured for autonomous or semi-autonomous navigation, the one or more sensors may be the same sensors used for autonomous or semi-autonomous navigation. In some embodiments, the one or more sensors may be mounted on the exterior of the truck's cab (e.g., on the front, the sides, or the windshield of the cab) and/or trailer (e.g., on the back and/or sides of the trailer).

The one or more sensors may be used to detect any type of hazard posed by other vehicles, objects, or by the truck itself. For instance, the one or more sensors may detect a stopped vehicle in the path of the truck, an object other than a vehicle (e.g., fallen trees, debris, animals) in the path of the truck, a pothole or construction roadblock in the path of the truck, heavy traffic or a traffic incident in the path of the truck, a lane closure in the path of the truck, the presence of another vehicle attempting to merge into the lane of the truck, or the presence of another vehicle in an adjacent lane into which the truck is attempting to merge or is drifting.

Step 204 comprises identifying a direction of the hazard relative to a driver of the truck. The direction of the hazard may be identified by the one or more sensors and provided to a computing system that is configured to generate audio signals for one or more speakers corresponding to a spatial audio alert. The audio signals may cause the one or more speakers to emit an audible alert that sounds as though it originated from the direction of the hazard (or from a location based on the direction of the hazard), thereby informing the driver where the hazard is located.

Step 206 comprises generating a spatial audio alert. The spatial audio alert may comprise a sound that originates or sounds as though it originates from a location based on the direction of the hazard. The location may be based on the direction of the hazard rather than the precise direction of the hazard because directing a driver's attention to the precise direction of the hazard may be less helpful in some circumstances. For example, if a hazard is located in a driver's blind spot, emitting an audible alert that sounds as though it originates from that direction may be unhelpful. Accordingly, the spatial audio alert may be configured to sound as though it originates from a different location which is based on, but is not precisely, the direction of the hazard.

In some embodiments, different spatial audio alerts may correspond to different types of hazards. A spatial audio alert may comprise a spoken language alert, tone, beep, chime, or any combination thereof. A spoken language alert may indicate specific information about a particular hazard, such as the type, location, and/or severity of the hazard.

In some embodiments, the spatial audio alert may be dynamic. As described above with reference to FIG. 1, the volume of the spatial audio alert may be dynamically adjusted as the distance between the truck and the hazard changes (e.g., the volume of the spatial audio alert may become louder as the truck becomes closer to the hazard). The content of the spoken language alert may also be dynamically adjusted as the distance between the truck and the hazard changes.

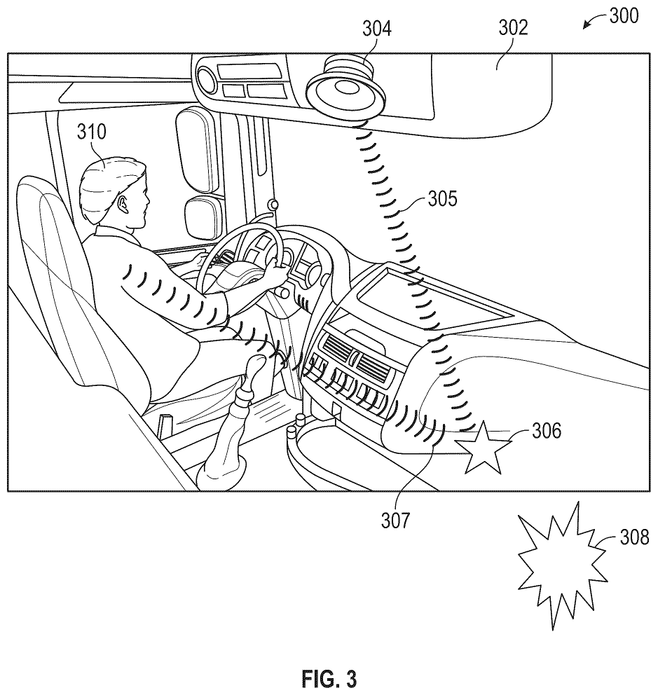

The manner in which the spatial audio alert is generated may depend on the type of speaker(s) present in the truck. In some embodiments, the truck may include one or more ultrasonic transducers disposed in the cab of the truck. An exemplary system for generating spatial audio alerts using an ultrasonic transducer is illustrated in FIG. 3. The system 300 may include one or more ultrasonic transducers 304 disposed in the cab of a truck 302. As described above with reference to FIG. 1, ultrasonic transducers are devices that can generate ultrasound energy, which has a frequency greater than about 20 kHz. Due to its high frequency and short wavelength, ultrasound energy can be transmitted in a concentrated directional beam and can be modulated with audio content to generate spatial audio alerts.

In some embodiments, the one or more ultrasonic transducers 304 may be placed in various positions within the cab of the truck. The position of the one or more ultrasonic transducers 304 may be selected to minimize the possibility of interference with the ultrasonic beams emitted by the one or more ultrasonic transducers. For example, as shown in FIG. 3, one or more ultrasonic transducers 304 may be mounted on the ceiling of the cab of the truck in order to minimize the possibility of the driver or a passenger interfering with the ultrasonic beams. In some embodiments, the one or more ultrasonic transducers may be mounted on the interior windshield of the truck, the dashboard, the rearview mirror, the center console, the doors, the pillars, the back wall, the floor, or any other suitable location within the cab of the truck. In some embodiments, a truck may be equipped with a single ultrasonic transducer that is configured to emit radiation in a plurality of directions. In some embodiments, a truck may be equipped with a plurality of ultrasonic transducers that may be configured to operate in tandem. For the sake of brevity, only one ultrasonic transducer is illustrated in FIG. 3.

In some embodiments, an ultrasonic transducer 304 can emit a modulated ultrasonic carrier wave 305. Modulated ultrasonic carrier wave 305 may be an ultrasonic carrier wave modulated with an audio signal. The audio signal may be generated by a computing system, such as computing system 110 described above with reference to FIG. 1. The computing system may be integrated into the truck itself or may be a separate computing system configured to generate modulated audio signals for ultrasonic transducer 304. The audio signal generated by the computing system may be an alert corresponding to a hazard 308 detected by one or more sensors of the truck. As described above with reference to FIG. 1, the alert may include a spoken language alert that communicates the nature, location, and/or severity of the hazard, a beep, a tone, a chime, or any combination thereof. The hazard 308 to which the alert corresponds may be a stopped vehicle in the path of the truck, an object other than a vehicle (e.g., fallen trees, debris, animals) in the path of the truck, a pothole or construction roadblock in the path of the truck, heavy traffic or a traffic incident in the path of the truck, a lane closure in the path of the truck, the presence of another vehicle attempting to merge into the lane of the truck, or the presence of another vehicle in an adjacent lane into which the truck is attempting to merge or is drifting.

Because ultrasound has a frequency that is around or higher than the upper audible limit of human hearing, the modulated ultrasonic carrier wave 305 may be inaudible when emitted from ultrasonic transducer 304. However, when modulated ultrasonic carrier wave 305 contacts an interior surface 306 of the cab of the truck, modulated ultrasonic carrier wave 305 may demodulate back into the audible frequency spectrum and become a demodulated ultrasonic carrier wave 307. As a result, an audible alert may be generated, wherein the audible alert sounds to a driver 310 as though the alert originated from the location at which modulated carrier wave 305 contacted interior surface 306.

The location at which modulated carrier wave 305 contacts interior surface 306 may be based on the perceived location of a hazard 308 detected by one or more sensors of the truck, such as sensors 106 described above with reference to FIG. 1. In some embodiments, the location at which modulated carrier wave 305 contacts interior surface 306 may be a location that is in the direction of the hazard 308 relative to driver 310 (e.g., along the straight line from driver 310 to hazard 308). In some embodiments, the contact may occur at a location that is based on the direction of the hazard 308 relative to driver 310 but is not along the direct path from driver 310 to hazard 308. For example, a driver 310 may attempt to merge into an adjacent lane, and the one or more sensors of the truck may identify a second vehicle already traveling in the adjacent lane. If the second vehicle is located in a blind spot of driver 310, emitting an audible alert that sounds as though it originates from that direction may be unhelpful. Accordingly, ultrasonic transducer 304 may direct modulated ultrasonic carrier wave 305 toward a different location that is based on, but is not exactly, the direction of the hazard (e.g., toward a side view mirror with which driver 310 can better view hazard 308).

In some embodiments, interior surface 306 may be a side wall, a seat, a dashboard, or other surface within the cab 302. Accordingly, interior surface 306 may be made from a variety of different materials, such as metal, plastic, rubber, fabric, leather, or a combination thereof. In some embodiments, the material of interior surface 306 may affect the manner in which modulated ultrasonic carrier wave 305 deforms upon contact, which may affect the quality of the audible alert produced. In some embodiments, ultrasonic transducer 304 may configured to be tuned to generate ultrasonic carrier waves 305 with properties that are based on the type of interior surface or surfaces 306 present within truck cab 302. The ability to tune ultrasonic transducer 304 may be particularly useful in a retrofit, where an existing truck is outfitted with an ultrasonic transducer that was not specifically designed for that truck.

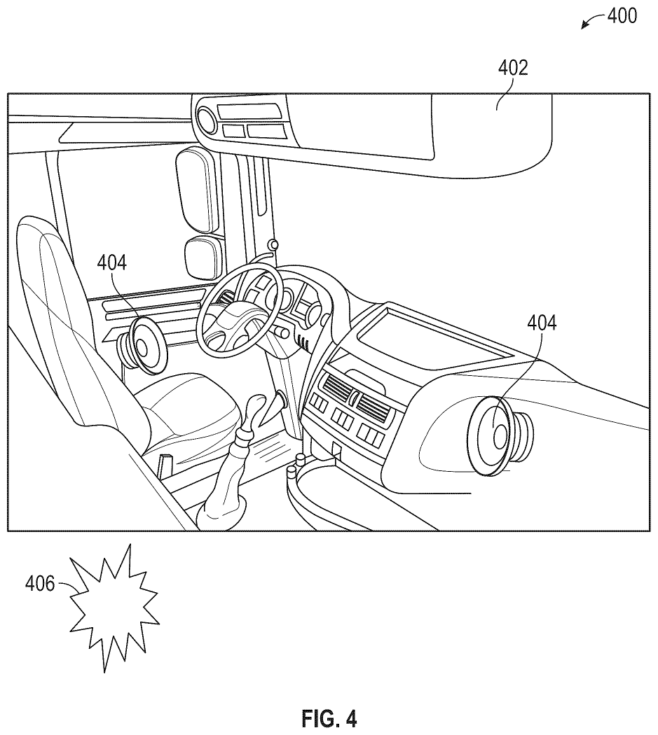

In some embodiments, a spatial audio alert may be generated using a plurality of audio speakers instead of or in addition to an ultrasonic transducer. FIG. 4 illustrates an exemplary system for generating spatial audio alerts using a plurality of conventional audio speakers. The system 400 may include a plurality of audio speakers 404 disposed in the cab of a truck 402. Audio speakers may include, but are not limited to, car speakers, loudspeakers, wired speakers, wireless speakers, Bluetooth speakers, speakers equipped with spatial audio processing technology, or any other suitable type of speaker that is not an ultrasonic transducer. In some embodiments, the plurality of audio speakers 404 may be fixed in the cab of the truck (e.g., as built-in car speakers). For the sake of brevity, FIG. 4 only illustrates two exemplary speakers; however, a truck may be equipped with 2, 3, 4, 5, 6, 7, 8, 9, 10, 11, 12, or more speakers.

Audio speakers 404 may be configured to generate an audible alert corresponding to a hazard 406 detected by one or more sensors of the truck. In some embodiments, audio speakers 404 may be configured to generate an audible alert that sounds as though it originates from the direction of the hazard (or a location based on the direction of the hazard). Spatial audio effects can be accomplished by controlling the phase and/or amplitude of the sound waves emitted from one or more of the plurality of speakers. The phase of a wave indicates the position of the wave at a given point in time on a repetitive waveform cycle (i.e., the fraction of the cycle that has been completed up to the given point in time). The amplitude of a wave is a measure of the relative strength (energy) of a wave. With respect to sound, amplitude is directly related to volume.

Manipulating the phase and/or amplitude of the sound waves can cause an audible alert to sound to a driver as though the audible alert originates from a specific location, even if there is no speaker in that location, due to how sound is perceived binaurally. When a sound is emitted, an individual may hear the sound in each ear at a slightly different time and volume. For example, if a sound originates from a source located to the right of an individual, the sound may reach the individual's right ear more quickly than it reaches their left ear. The sound may also be louder in the individual's right ear. Based on the time delays and volume differences experienced between ears, the individual can subconsciously infer the origin of the sound. Thus, by controlling the phase and amplitude of sound waves to mimic the time delays and volume differences that a user would experience if a sound originated from a desired location, the system may create the illusion that the alert originated from the desired location without the need for placing speakers in that location.

In some embodiments, spatial audio effects may be achieved by providing the same audio signal to a plurality of speakers and slightly delaying the output from one or more speakers as compared to a first speaker by adjusting the phase of one or more waves emitted from the speakers. Delaying the output from one or more speakers can create the illusion that the sound originates from a location near where the first speaker emitted a signal, since sound emitted from a closer source reaches the ear of a listener first.

In some embodiments, spatial audio effects can be generated using crosstalk cancellation techniques. The system may create an out-of-phase version of an opposite channel (e.g., an audio signal for a left speaker may be slightly out-of-phase with the audio signal for a right speaker so that the left speaker sound reaches the left ear on a time delay). The signals may be timed such that the out-of-phase sound from the left speaker reaches the left ear at the same time as the right speaker's sound, which puts the sound waves from the right and left speakers in perfect time alignment but out of phase, resulting in cancellation of the right speaker's sound.

In some embodiments, phase can be manipulated to take advantage of constructive and destructive interference. Constructive interference occurs when two or more waves with the same phase and amplitude are driven simultaneously. When this occurs, the waves add together, resulting in a wave that has twice the amplitude (and twice the volume) of the individual waves. Destructive interference occurs when waves having the same amplitude and opposite phase are driven simultaneously. When this occurs, the waves cancel each other out, resulting in silence. Partial interference occurs when waves are not completely constructive or completely destructive, and can result in sound amplification or reduction, depending on the nature of the interference. In some embodiments, interference principles may be used to create spatial audio effects (e.g., by driving an identical output from two speakers simultaneously in order to amplify a sound in a given location).

In addition to controlling the phase of waves emitted from different speakers, the system may be configured to control the amplitude of the waves emitted from different speakers to achieve spatial audio effects. For example, the plurality of speakers may be configured to emit the same sound or different sounds at different volumes by adjusting the amplitude of waves emitted from the one or more speakers.

In some embodiments, spatial audio effects can be generated using virtual surround sound techniques, which use phase and amplitude control as well as reflections off of the interior walls of the truck cab to create the desired effect. In virtual surround sound, speakers may be configured to reflect sound waves off the walls at specific times and locations. Reflecting sound waves off the walls may cause the sound waves to reach a listener's ears later and at a different volume than sound perceived directly from a speaker. By taking advantage of these timing delays, virtual surround sound systems can create the illusion that sound is anywhere in the cab of the truck.

In some embodiments, the speakers may be calibrated by adjusting the amplitude and phase of each frequency from each speaker. If the speakers are not calibrated, destructive interference effects may create one or more “dead zones” in which sound waves from two or more speakers cancel each other out, resulting in low sound or no sound. The speakers may be calibrated during manufacture of the truck or may be calibrated by a user after manufacturing is complete, for example by using a test instrument configured to calibrate the speakers of the particular truck in which the speakers are installed.

In one or more examples, the disclosed systems and methods utilize or may include a computer system. FIG. 5 illustrates an exemplary computing system according to one or more examples of the disclosure. Computer 500 can be a host computer connected to a network. Computer 500 can be a client computer or a server. As shown in FIG. 5, computer 500 can be any suitable type of microprocessor-based device, such as a personal computer, workstation, server, or handheld computing device, such as a phone or tablet. The computer can include, for example, one or more of processor 510, input device 520, output device 530, storage 540, and communication device 560. Input device 520 and output device 530 can correspond to those described above and can either be connectable or integrated with the computer.

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random-access memory (RAM), cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein.

Software 550, which can be stored in storage 540 and executed by processor 510, can include, for example, the programming that embodies the functionality of the present disclosure (e.g., as embodied in the systems, computers, servers, and/or devices as described above). In one or more examples, software 550 can include a combination of servers such as application servers and database servers.

Software 550 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 440, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A system for generating spatial audio alerts, the system comprising:
one or more ultrasonic transducers disposed in a cab of a truck;
one or more sensors disposed in or around the truck;
one or more processors; and
one or more computer readable media storing instructions that, when executed by the one or more processors, cause the system to perform a method comprising:
detecting, by the one or more sensors, a hazard;
identifying a direction of the hazard relative to a driver of the truck; and
generating a spatial audio alert, wherein generating a spatial audio alert comprises emitting, from the one or more ultrasonic transducers, an ultrasonic carrier wave modulated with audio content directed toward a location based on the direction of the hazard, wherein the ultrasonic carrier wave demodulates upon contacting an interior surface of the cab of the truck and generates a spatial audio alert audible from the location based on the direction of the hazard.

2. The system of claim 1, wherein the one or more ultrasonic transducers are configured to emit ultrasonic carrier waves in a plurality of directions.

3. The system of claim 1, wherein the one or more ultrasonic transducers are attached to at least one of: a ceiling of the cab of the truck, an interior surface of a windshield of the cab of the truck, a dashboard of the cab of the truck or an instrument panel thereof, a console of the cab of the truck, a door of the cab of the truck, a wall of the cab of the truck, a pillar of the cab of the truck, or a floor of the cab of the truck.

4. The system of claim 1, wherein at least one sensor is used for autonomous navigation.

5. The system of claim 1, wherein at least one sensor is attached to a trailer of the truck.

6. The system of claim 1, wherein the hazard comprises a stopped vehicle, a merging vehicle, an object, a pothole, a construction roadblock, a traffic incident, or a lane closure.

7. The system of claim 1, wherein the spatial audio alert comprises a spoken language alert.

8. The system of claim 7, wherein the spoken language alert comprises a nature of the hazard.

9. The system of claim 7, wherein the spoken language alert comprises a location of the hazard.

10. The system of claim 1, wherein the method further comprises:
repeatedly emitting the spatial audio alert;
determining that the hazard no longer exists; and
ceasing to emit the spatial audio alert.

11. The system of claim 10, wherein repeatedly emitting the spatial audio alert comprises dynamically adjusting a volume of the spatial audio alert based on a distance between the hazard and the truck.

12. The system of claim 11, wherein the volume of the spatial audio alert increases as the distance between the hazard and the truck decreases.

13. The system of claim 1, wherein the truck is retrofitted with the one or more ultrasonic transducers.

14. A system for generating spatial audio alerts, the system comprising:
a plurality of speakers disposed in a cab of a truck;
one or more sensors disposed in or around the truck;
one or more processors; and
one or more computer readable media storing instructions that, when executed by the one or more processors, cause the system to perform a method comprising:
detecting, by the one or more sensors, a hazard;
identifying a direction of the hazard relative to a driver of the truck; and
generating a spatial audio alert, wherein generating a spatial audio alert comprises controlling a phase of an audio signal emitted from at least one speaker of the plurality of speakers to generate a spatial audio alert audible from a location based on the direction of the hazard.

15. The system of claim 14, wherein generating a spatial audio alert comprises controlling an amplitude of the audio signal emitted from the at least one speaker.

16. The system of claim 14, wherein the plurality of speakers are attached to at least one of: a ceiling of the cab of the truck, an interior surface of a windshield of the cab of the truck, a dashboard of the cab of the truck or an instrument panel thereof, a console of the cab of the truck, a door of the cab of the truck, a wall of the cab of the truck, a pillar of the cab of the truck, or a floor of the cab of the truck.

17. The system of claim 14, wherein at least one sensor is used for autonomous navigation.

18. The system of claim 14, wherein at least one sensor is attached to a trailer of the truck.

19. The system of claim 14, wherein the hazard comprises a stopped vehicle, a merging vehicle, an object, a pothole, a construction roadblock, a traffic incident, or a lane closure.

20. The system of claim 14, wherein the spatial audio alert comprises a spoken language alert.

21. The system of claim 20, wherein the spoken language alert comprises a nature of the hazard.

22. The system of claim 20, wherein the spoken language alert comprises a location of the hazard.

23. The system of claim 14, wherein the method further comprises:
repeatedly emitting the spatial audio alert;
determining that the hazard no longer exists; and
ceasing to emit the spatial audio alert.

24. The system of claim 23, wherein repeatedly emitting the spatial audio alert comprises dynamically adjusting a volume of the spatial audio alert based on a distance between the hazard and the truck.

25. The system of claim 24, wherein the volume of the spatial audio alert increases as the distance between the hazard and the truck decreases.
